(19) United States
(12) Patent Application Publication
(10) Pub. No.: US 2014/0191504 A1
(43) Pub. Date: Jul. 10, 2014

(54) PVC-Coated and Adaptive Pipe Coupling

(71) Applicant: Yijun Wu, Yixing City (CN)

(72) Inventor: Yijun Wu, Yixing City (CN)

(21) Appl. No.: 13/734,648

(22) Filed: Jan. 4, 2013

(51) Int. Cl. F16L 47/08

(52) U.S. Cl. CPC F16L 47/08
USPC 285/374

(57) ABSTRACT

This practical patent product relates to a pipe coupling, namely, a PVC-coated and adaptive pipe coupling. Its construction consists of male port and female port for interfacing purpose. The female port is configured with gasket-inserting groove. The gasket and male port are jointed through excessive interfacing. Compared with available technology, the practical patent product features simple construction, easy installation, firm connection and no damage to the coating layer thereof.

### TECHNICAL DOMAIN

This practical patent product relates to a pipe coupling, namely, a PVC-coated and adaptive pipe coupling.

### RELATED TECHNOLOGY

With respect to pipe couplings of existing technology, especially the PVC-coated pipe couplings, when in service, the PVC-coated inner wall of pipe couplings is vulnerable to abrasion with steel pipe which results in damage to the coating and impair air-tightness and shorter service life of pipe couplings.

### INVENTIVE CHARACTERISTICS

This patented product, targeting the above-stated problems, provides a PVC-coated and adaptive pipe coupling that offers a solution to technical problems that the coating of existing pipe coupling can be easily damaged.

This patented product adopts the following technical scheme to address such technical problems:

This practical patent product relates to a pipe coupling, namely, a PVC-coated and adaptive pipe coupling. Its construction consists of male port and female port for interfacing purpose. The female port is configured with gasket-inserting groove. The gasket and male port are jointed through excessive interfacing.

The fixing ring is located in the gasket groove, and such a gasket is fixed to the f ring.

The front end of its male port is in conic shape.

With respect to this inventive PVC-coated adaptive pipe coupling, gasket groove and fixing ring are fabricated on the male port with roll press process, with its female port made in conic shape for easier installation. Air-tightness can be achieved with gasket fixed in the groove and inserted into the female port.

Compared with available technology, this practical patent product is characterized with simple construction, easy installation, firm connection and no damage to the coating during installation.

### NOTES OF ATTACHED FIGURES

FIG. 1 is the structural diagram showing the inside of the PVC-coated adaptive pipe coupling (not inserted);

FIG. 2 is the structural diagram showing the inside of the PVC-coated adaptive pipe coupling (inserted);

### MODE OF APPLICATION

The detailed description of PVC-coated adaptive pipe coupling is given below with the help of the figures listed hereafter and specific case of application.

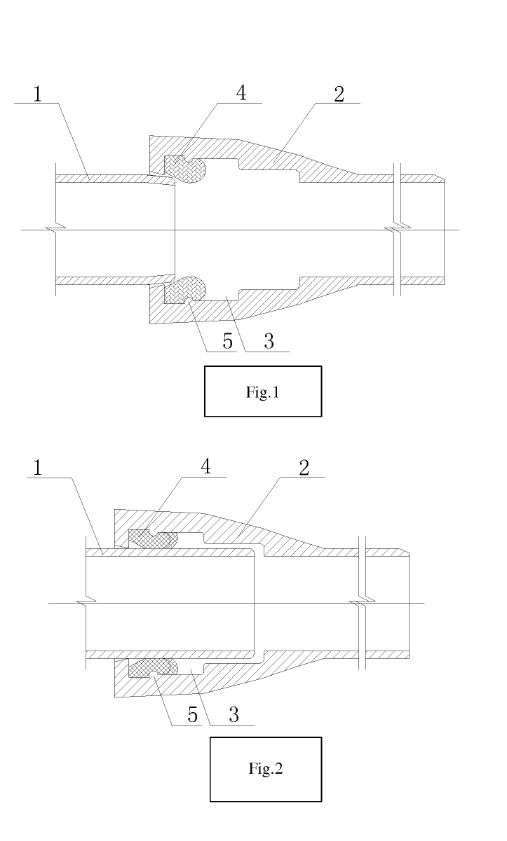

As shown in FIGS. 1 and 2, the PVC-coated adaptive pipe coupling is composed of female port 1 and male port 2 for interfacing purpose, the inside of the female port 2 is provided with gasket groove 3 with gasket 4 set in gasket groove 3. The gasket 4 and fitted female port 1 are jointed with excessive interfacing.

The fixing ring 5 is set in the gasket groove on gasket 3, and gasket 4 is fixed on fixing ring 5.

In this case, the front end of female port 1 is in conic shape.

The mode of application stated above represents just one case of the well-chosen ones for this patent product. General variations and alternatives made by technicians limited to the scope of technical proposal of this patent product shall fall in the coverage of IPR protection for it.

1. This practical patent product relates to a PVC-coated and adaptive pipe coupling, which is composed of male port and female port for interfacing purpose, The female port is provided with gasket groove where inserted male port is jointed with excessive interfacing.

2. The PVC-coated adaptive pipe coupling as stated in claim 1 is characterized with fixing ring in gasket installation groove and that gasket is fixed on fixing ring.

3. The PVC-coated and adaptive pipe coupling stated in claim 1 is characterized with conic-shaped front end at its male port.
